(19) United States
(12) Patent Application Publication
(10) Pub. No.: US 2023/0200471 A1
(43) Pub. Date: Jun. 29, 2023

(54) APPARATUS AND METHOD TO PROVIDE SINGLE-PLY PATHOGENICIDAL BARRIER BETWEEN FIRST AND SECOND REGIONS

(71) Applicant: X CELL, LLC, Tampa, FL (US)

(72) Inventors: Sunil PANCHAL, Tampa, FL (US); Pedro SOLER, Tampa, FL (US); Arlo HENDERSON, Tampa, FL (US); Damir PAMIC, Tampa, FL (US)

(21) Appl. No.: 17/926,758

(22) PCT Filed: May 21, 2021
(86) PCT No.: PCT/US2021/033635

§ 371 Date: Nov. 21, 2022

Related U.S. Application Data
(60) Provisional application No. 63/101,894, filed on May 21, 2020.

(51) Int. Cl. A41D 13/11; B32B 3/04; A62B 23/02

(52) U.S. Cl. CPC A41D 13/1192; B32B 3/04; A62B 23/025; B32B 2307/724

(57) ABSTRACT

A barrier is provided to be placed between a first region and a second region, to prevent passage of pathogens between the first and second regions. The barrier includes a single ply layer treated with pathogenicidal components. The single ply layer includes a first side directed toward the first region, and includes an outer surface coated with the pathogenicidal components such that pathogens in the first region are incident on the outer surface of the first side. The single ply layer also includes a second side directed toward the second region, and includes an outer surface coated with the pathogenicidal components such that pathogens in the second region are incident on the outer surface of the second side. The pathogenicidal components coated on the outer surfaces of the first and second side deactivate the pathogens incident on the outer surface of the respective first and second sides.

### CROSS-REFERENCE TO RELATED APPLICATIONS

This application claims benefit of Provisional Appln. No. 63/101,894, filed May 21, 2020, the entire contents of which are hereby incorporated by reference as if fully set forth herein, under 35 U.S.C. § 119(e).

### BACKGROUND

It is commonly known that pathogens such as viruses and bacteria are easily transmitted between people via direct and indirect contact. An example of direct transmission is when aerosolization of pathogens occur during exhalation, coughing, or sneezing, and is transferred to another individual. Indirect transmission occurs when pathogens contact and reside on an intervening surface such as doorknobs, countertops, tabletops, or on an individual's hand.

### SUMMARY

Techniques are provided for providing a barrier treated with pathogenicidal components positioned between a first region and a second region to kill or deactivate pathogens (e.g. virus particles) and thus prevent transmission of pathogens between the first and second regions.

The inventors recognized that various conventional masks are available which attempt to prevent the transmission of pathogens between two regions. In one example, conventional masks are available which provide an interior layer treated with pathogenicidal components (e.g. virucidal components) sandwiched between two exterior layers that are not treated with pathogenicidal components. Although the interior layer of these conventional masks is used to kill or deactivate pathogens, the untreated exterior layers of these masks become contaminated when pathogens contact these exterior layers. Consequently, when the user touches or removes the mask, they contaminate their hand and thus may subsequently contaminate themselves (e.g. touching their face) or other surfaces (e.g. by touching these surfaces). Additionally, the inventors of the present invention recognized that disposing this contaminated mask may cause further contamination of other surfaces that make contact with the exterior layer during disposal. To overcome this drawback of conventional masks, the inventors of the present invention developed a single ply barrier that is treated with pathogenicidal components that can be worn over the face as a facial cover. This improved single ply barrier advantageously kills or deactivates incident pathogens and thus minimizes the risk of contamination of the barrier. Thus, the improved single ply barrier minimizes the risk of contamination of the user (e.g. when touching or disposing of the barrier) and other surfaces (e.g. when the barrier is discarded).

The inventors recognized other drawbacks of conventional masks. For example, since the conventional masks include multiple layers, the air permeability and thus the breathability of these masks is severely limited. This can pose health concerns for individuals who suffer from respiratory illnesses (e.g. asthma). Additionally, this can severely restrict the breathing of athletes who may be required to wear such conventional masks during sports activity (e.g. due to laws and/or regulations governing viral pandemics). To overcome this significant drawback of conventional masks, the inventors of the present invention developed the single ply barrier that is treated with pathogenicidal components that can be worn over the face. The improved barrier only includes a single ply layer, and thus has significantly higher air permeability and breathability than conventional masks, while at the same time being at least as effective in killing or deactivating pathogens.

The inventors also recognized another drawback of conventional masks. For example, during viral pandemics there is a well-known shortage of certain masks (e.g. N95) used by medical professionals. This shortage is facilitated by the frequency by which these masks are discarded after a certain amount of use. Although there are certain methods that can be used to sterilize such masks after multiple uses, these sterilization methods can damage the mask material and thus affect the performance of these masks during reuse. To overcome this noted drawback of shortage of certain masks, the inventors of the present invention developed a single ply barrier that is treated with pathogenicidal components that can be used to enclose a conventional mask (e.g. N95) to minimize contamination of the mask. This advantageously extends the lifetime of the conventional mask and thus reduces the instance of shortage of the conventional masks. Additionally, the single ply barrier also improves upon other methods (e.g. sterilization) that may affect the performance of the conventional masks during reuse.

The inventors of the present invention noticed that attempts to reduce transmission include prior inventions of masks. However, the limitations of masks are that the external surface (facing away from the user, and the internal surface (facing the user) are inherently contaminated whether from the environment or from the user and thus present a risk for infection if an individual does not remove and dispose of the mask correctly. This represents a risk to the user, as well as others via indirect transmission. Also, in the situation of a pandemic, with the result of shortages of personal protective equipment, many individuals are forced to reuse protective masks, and often do not have a reliable means of sterilizing a mask for reuse. Furthermore, some methods of sterilization result in a breakdown of the fibers of the mask, thereby reducing its effectiveness in filtering out pathogens. When shortages occur, many individuals are forced to use simple cloth face covers, which are not reliable for preventing airborne transmission, and still pose a risk to enable indirect transmission when removed.

In one embodiment, the present invention provides a cover for a mask, and has embedded pathogenicidal components (e.g. virucidal and/or bactericidal components), providing protection for both the external and internal surfaces of a mask, preventing/reducing contamination of a mask, thereby improving safety if reuse is necessary, and by inactivating or destroying pathogens, reducing risk of indirect transmission when the cover is removed and disposed. If a mask was not available for use, the individual may also elect to use this invention as face cover and provide a measure a safety due to the embedded pathogenicidal and bactericidal components.

In a first set of embodiments, a barrier is provided that is configured to be placed between a first region and a second region, to prevent passage of pathogens between the first region and the second region. The barrier includes a single ply layer treated with pathogenicidal components. The single ply layer includes a first side directed toward the first region, where the first side includes an outer surface coated with the pathogenicidal components such that pathogens in the first region are incident on the outer surface of the first side. The single ply layer also includes a second side directed toward the second region, where the second side includes an outer surface coated with the pathogenicidal components such that pathogens in the second region are incident on the outer surface of the second side. The pathogenicidal components coated on the outer surfaces of the first side and the second side are configured to deactivate the pathogens incident on the outer surface of the respective first side and the second side.

In a second set of embodiments, a facial cover to be worn by a user is provided. The facial cover includes a barrier according to the first set of embodiments and a secondary layer not treated with pathogenicidal components positioned between the second side of the single ply layer and the face of the user. The barrier is configured to deactivate pathogens incident from the external surroundings of the user to prevent contamination of the secondary layer.

In a third set of embodiments, a method is provided for forming the barrier according to the first set of embodiments. The method includes wetting material with a solution comprising pathogenicidal components with a concentration having a value for a first time period. The method further includes drying the material for a second time period after the first time period. The method further includes measuring a value of air permeability of the dried material after the second time period. The method further includes comparing the measured value of the air permeability with a threshold value of the air permeability. The method further includes using the dried material in step b) to form the single ply layer based on the measured value of the air permeability being greater than the threshold value.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a schematic diagram that illustrates an example of a single ply barrier layer with pathogenicidal components between a first and second region, according to an embodiment;

FIG. 2A is an image that illustrates an example of a perspective view of the single ply barrier layer of FIG. 1 worn as a facial cover, according to an embodiment;

FIG. 2B is an image that illustrates an example of a perspective view of the single ply barrier layer of FIG. 1 worn as a facial cover, according to an embodiment;

FIG. 2C is an image that illustrates an example of a cross-sectional view of the single ply barrier layer of FIG. 2A taken along the line 2C-2C;

FIG. 2D is an image that illustrates an example of a front view of an oval shaped facial cover of FIG. 2A, according to an embodiment;

FIG. 2E is an image that illustrates an example of a front view of a facial cover of FIG. 2A with an attached elastic fastener, according to an embodiment;

FIG. 2F is an image that illustrates an example of a front view of the facial cover of FIG. 2A taking an arcuate shape, according to an embodiment;

FIG. 2G is an image that illustrates an example of a front view of an elastic fastener to be used to secure the facial cover of FIG. 2F to the face, according to an embodiment;

FIG. 2H is an image that illustrates an example of a rear view of the facial cover of FIG. 2F with elastic to affix the facial cover to the face, according to an embodiment;

FIG. 3A is an image that illustrates an example of a perspective view of a facial cover including the single ply barrier layer of FIG. 1 covering a mask, according to an embodiment;

FIG. 3B is an image that illustrates an example of a cross-sectional view of the facial cover of FIG. 3A taken along the line 3B-3B;

FIG. 3C is an image that illustrates an example of a perspective view of a facial cover including the single ply barrier layer of FIG. 1 enclosing a mask, according to an embodiment;

FIG. 3D is an image that illustrates an example of a cross-sectional view of the facial cover of FIG. 3C taken along the line 3D-3D;

FIG. 3E is an image that illustrates an example of a front view of the single ply layer of FIG. 3C before enclosing the mask, according to an embodiment;

FIG. 3F is an image that illustrates an example of a rear view of the single ply layer of FIG. 3A before enclosing the mask, according to an embodiment;

FIG. 4A is an image that illustrates an example of a schematic diagram of the single ply barrier layer of FIG. 1 used as an air filter in an air conditioning system, according to an embodiment;

FIG. 4B is an image that illustrates an example of a schematic diagram of the air filter of the air conditioning system of FIG. 4A, according to an embodiment;

FIG. 5 is an image that illustrates an example of a schematic diagram of the single ply barrier layer of FIG. 1 used to form a garment worn by a medical professional, according to an embodiment;

FIG. 6 is an image that illustrates an example of a schematic diagram of the single ply barrier layer of FIG. 1 used as a filter in a ventilator, according to an embodiment;

FIG. 7 is a flow chart that illustrates an example of a method for forming the single ply barrier layer of FIG. 1, according to an embodiment;

FIG. 8A is an image that illustrates an example of a graph that depicts an intensity of X-ray Diffraction (XRD) of the single ply barrier layer of FIG. 1, according to an embodiment;

FIG. 8B is an image that illustrates an example of different miller indices used for the XRD depicted in the graph of FIG. 8A;

FIG. 9A is an image that illustrates an example of light scattering of particles downstream of a conventional mask, according to an embodiment;

FIG. 9B is an image that illustrates an example of light scattering of particles downstream of a conventional surgical mask, according to an embodiment;

FIG. 9C is an image that illustrates an example of light scattering of particles downstream of the single ply barrier layer of the facial cover of FIG. 2A, according to an embodiment; and

FIG. 10 is an image that illustrates an example of a graph that depicts viral filtration efficiency (VFE) of the single ply barrier layer of FIG. 1, according to an embodiment.

### DETAILED DESCRIPTION

A method and apparatus are described for providing a barrier including a single ply layer treated with pathogenicidal components between a first and second region to prevent passage of pathogens between the first and second regions. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of a barrier positioned between a first region and a second region to prevent passage or transmission of pathogens between the first and second regions. However, the invention is not limited to this context and includes a barrier including a single ply layer with pathogenicidal components that is positioned between the first and second regions to prevent passage or transmission of viral particles between the first and second regions.

For purposes of this description, “barrier” means a single ply layer of material treated with pathogenicidal (e.g. virucidal or bactericidal components) and positioned between a first and second region to prevent or reduce the instance of transmission of pathogens between the first and second regions. For purposes of this description, “single ply layer” means a single layer of material and excludes multiple layers of the material or additional layers of a different material. For purposes of this description, “pathogenicidal components” means any chemical or molecule having the capacity to or tending to destroy or inactivate pathogens and includes (but is not limited to) virucidal components and bactericidal components. For purposes of this description, “virucidal components” means any chemical or molecule having the capacity to or tending to destroy or inactivate viruses. For purposes of this description, “bactericidal components” means any chemical or molecule having the capacity to or tending to destroy or inactivate bacteria. For purposes of this description, “mask” means a conventional facial mask worn to reduce the instance of transmission of pathogens (e.g. N95 mask) and including multiple layers of material. For purposes of this description, “facial cover” means a cover worn over the face that includes the barrier disclosed herein.

In one embodiment, the present invention provides a cover for a mask, or cover for the face, suitable for wear, which inhibits the passage of viruses and bacteria, and is treated with a compound designed to destroy viruses and bacteria. This cover will allow the user to reuse the mask, whether it be a surgical mask, N95 mask, KN95 mask, P100 mask, or other masks that an individual may use, by reducing contamination of the mask. This invention will also reduce contamination of the user's environment upon disposal, due to the treatment with a compound designed to kill viruses and bacteria.

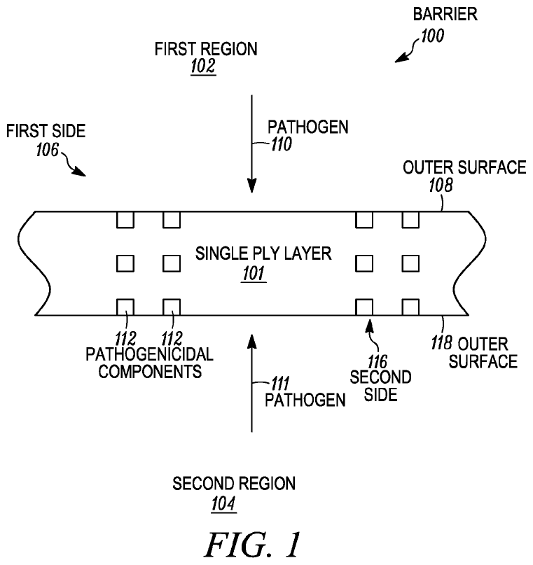

FIG. 1 is a schematic diagram that illustrates an example of a barrier 100 positioned between a first region 102 and a second region 104. In an embodiment, a pathogen 110 (e.g. viral particle in an aerosol droplet) is incident from the first region 102 onto the barrier 100. In another embodiment, a pathogen 111 (e.g. viral particle in an aerosol droplet) is incident from the second region 104 onto the barrier 100. Although FIG. 1 depicts pathogens 110, 111 incident on the single ply layer 101 from both regions 102, 104, in some embodiments only one of the pathogens 110 or 111 from one of the regions 102 or 104 are incident on the single ply layer 101.

In an embodiment, the barrier 100 includes a single ply layer 101 positioned between the first region 102 and the second region 104. As shown in FIG. 1, in one embodiment the single ply layer 101 extends along an interface between the first and second regions 102, 104 by a sufficient distance to prevent passage of the pathogens 110, 111 between the first and second regions 102, 104. This distance that the single ply layer 101 extends along the interface of the first and second regions 102, 104 depends on the specific arrangement and context of the first and second regions 102, 104. In one embodiment, the single ply layer 101 only includes a single layer of material and excludes additional layers positioned between the first region 102 and the second region 104. In an example embodiment, the single ply layer 101 comprises woven or nonwoven layers of material, including one or more of microfibril cloth, tightly woven cotton cloth, absorbent cellulose fiber layers, woven fabrics, textiles, polymer-laid fabrics (e.g., spunbonded and meltblown), dry-laid and wet-laid non-wovens, etc. In an example embodiment, polypropylene is the preferred material for the single ply layer 101. In an example embodiment, the single ply layer 101 includes pores with a dimension in a certain range (e.g. about 4 microns and/or in a range from about 3 microns to about 5 microns and/or in a range from about 2 microns to about 6 microns).

In an embodiment, the single ply layer 101 includes pathogenicidal components 112 within the layer. In one embodiment, the single ply layer 101 is treated with pathogenicidal components 112 using a method discussed hereinafter. In one embodiment, the single ply layer 101 is treated with single or combinations of components that possess virucidal and/or bactericidal properties. In an example embodiment, these components include one or more of acids, salts, or esters. In one example embodiment, the components include citric acid, any carboxylic acid, or any mineral acid. In another example embodiment, the components include one or more of citrate esters, vitamin C esters, pyruvate, citrate, isocitrate, ketoglutarate, succinate, fumarate, malate, oxaloacetate or basic components (e.g., such as soaps, sodium lauryl sulfate, quaternary ammonium salts; cationic, anionic and nonionic surfactants, or tallow amines). In an example embodiment, the concentration of the acidic components may range from about 11% to about 100% of the acid, salt, or ester, and the concentration of the basic components may range from about 0.1% to about 10% of the surfactant, salt or ester. In yet another example embodiment, other pathogenicidal components (e.g., virucidal and/or bactericidal components) that may be utilized include NaCl, zinc disodium EDTA, copper, nickel, iodine, manganese, tin, boron, or silver; salts thereof; chelants thereof; chelactants thereof; surfactant-linked compositions thereof; or ions thereof. In an example embodiment, the metal virucidal composition may range from about 1% to about 100% solution, and also colloids and phycocolloids may be utilized.

In another embodiment, the single ply 101 is treated with the pathogenicidal components 112 across an entire thickness of the single ply layer 101 (where thickness is a dimension perpendicular to the interface between the regions 102, 104 and extending from the first region 102 to the second region 104). As shown in FIG. 1, in one example embodiment, the single ply layer 101 is treated with the pathogenicidal components 112 along an entire thickness of the single ply layer 101 from an outer surface 108 of a first side 106 of the single ply layer 101 to an outer surface 118 of a second side 116 of the single ply layer 101. In an example embodiment, the pathogenicidal components 112 include one or more of salt, acid and esters. FIG. 1 is not drawn to scale and thus although portions of the single ply layer 101 do not include the pathogenicidal components 112, this is merely for ease of illustration and in one embodiment the pathogenicidal components 112 are provided along the length (e.g. uniformly arranged along the entire length) of the single ply layer 101 over the interface between the regions 102, 104.

In an example embodiment, salt is effective as a virucidal component to kill and/or deactivate a viral particle, since the viral particle is usually incident on the single ply layer 101 in a water droplet (e.g. aerosol). Once the water droplet containing the viral particle makes contact with the single ply layer 101, salt crystals within the single ply layer 101 dissolve in the water droplet. Over time, the water droplet evaporates, thus reducing the water volume containing the viral particle and consequently increasing the relative salt concentration. Once the salt concentration reaches a sufficient level, the salt deactivates and/or kills the viral particle.

In an embodiment, the first side 106 of the single ply layer 101 is directed toward the first region 102. In an example embodiment, the outer surface 108 of the first side 106 is coated with the pathogenicidal components 112 and is directed toward the first region 102 such that the pathogen 110 in the first region 102 is incident on the outer surface 108 of the first side 106. In another example embodiment, the outer surface 108 of the first side 106 is the first surface that is encountered by the pathogen 110 incident on the single ply layer 101 (e.g. no other layer or surface or component of the barrier 100 interacts with the pathogen 110 before the outer surface 108).

In an embodiment, the second side 116 of the single ply layer 101 is directed toward the second region 104. In an example embodiment, the outer surface 118 of the second side 108 is coated with the pathogenicidal components 112 and is directed toward the second region 102 such that the pathogen 111 in the second region 104 is incident on the outer surface 118 of the second side 116. In another example embodiment, the outer surface 118 of the second side 116 is the first surface that is encountered by the pathogen 111 incident on the second side 116 (e.g. no other layer or surface or component of the barrier 100 makes contact with the pathogen 111 before the outer surface 118). In an example embodiment, the pathogenicidal components 112 coated on the outer surfaces 108, 118 of the first side 106 and the second side 116 are configured to deactivate the pathogens 110, 111 (e.g. viral particles in aerosol) incident on the outer surfaces 108, 118 of the respective first side 106 and the second side 116.

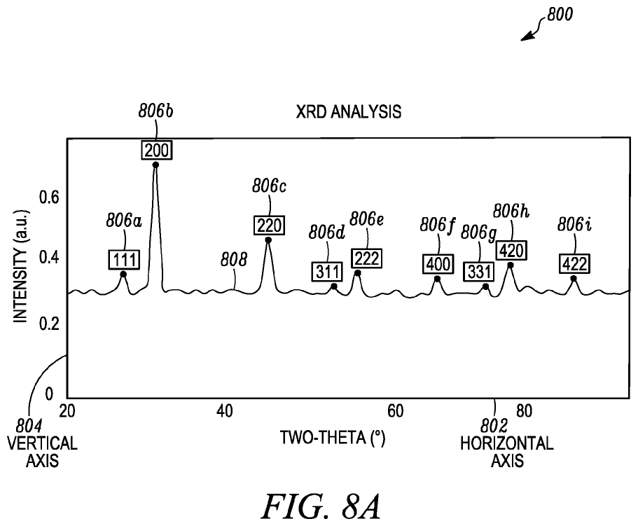

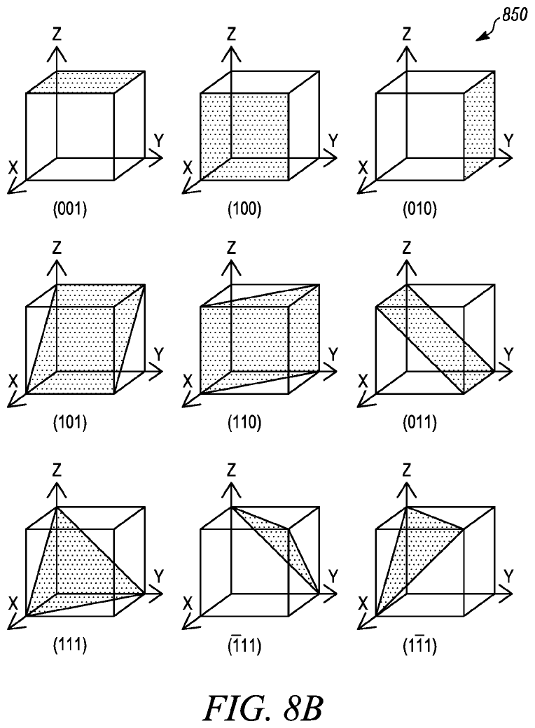

In an embodiment, the pathogenicidal components 112 comprise salt with a level of crystallization of across a thickness of the single ply layer 101 from the outer surface 108 of the first side 106 to the outer surface 118 of the second side 116. In an embodiment the level of crystallization of the salt is measured based on X-ray Diffraction (XRD) Analysis as discussed hereafter with respect to FIGS. 8A and 8B.

In an embodiment, the single ply layer 101 has an air permeability that is greater than a threshold value of air permeability. In one embodiment, the air permeability is based on a value of an air pressure difference across the single ply layer 101 (e.g. between the first side 106 and the second side 116) based on an airflow passed through the single ply layer 101 at a constant flowrate (e.g. about 8 L/min or in a range from about 4 L/min to about 12 L/min). In an example embodiment, the air permeability of the single ply layer 101 is such that the air pressure difference is less than about 0.2 mm H₂O/cm². In another example embodiment, the air permeability is such that the air pressure difference is less than about 0.1 mm H₂O/cm².

In an embodiment, the single ply layer 101 has a viral filtration efficiency between the first and second regions 102, 104 that is above a threshold filtration efficiency (e.g. 85%). In one embodiment, the viral filtration efficiency of the single ply layer 101 is at least 95% between the first region 102 and the second region 104.

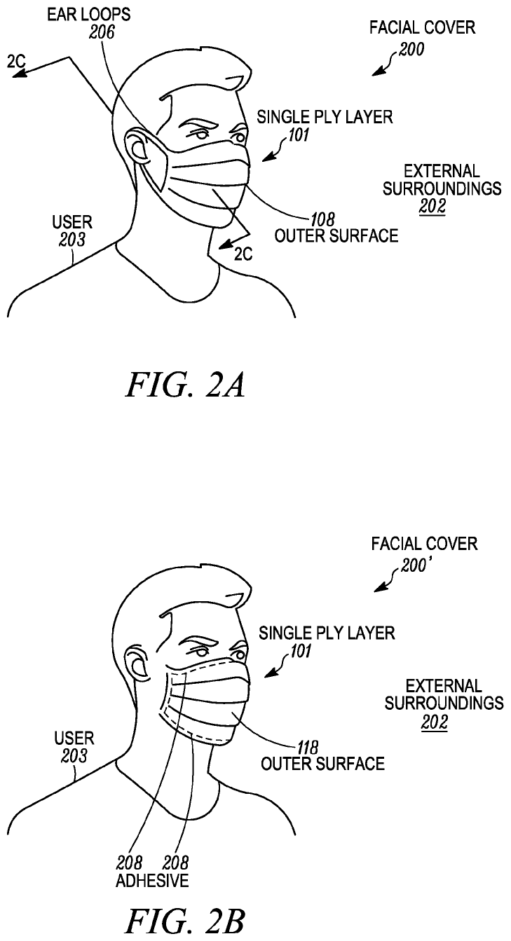

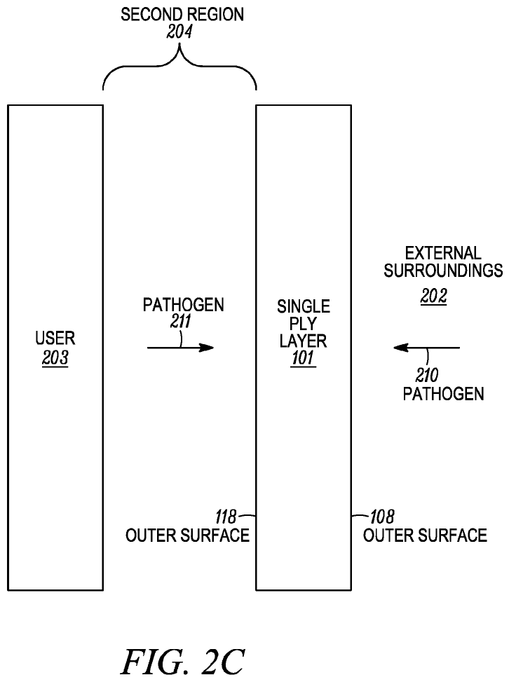

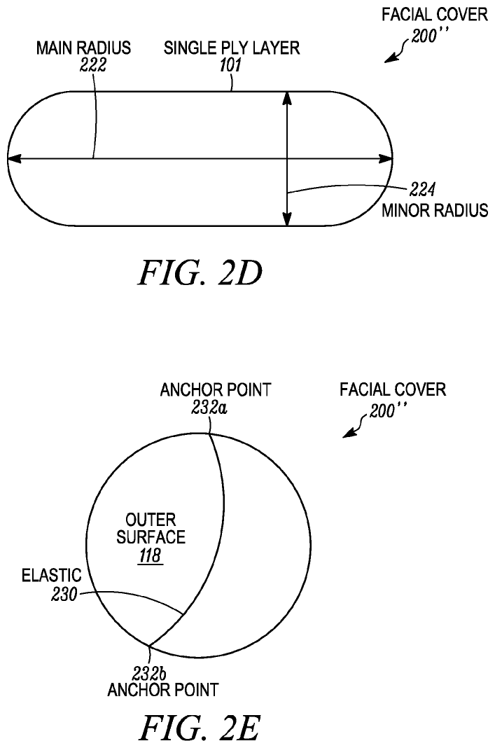

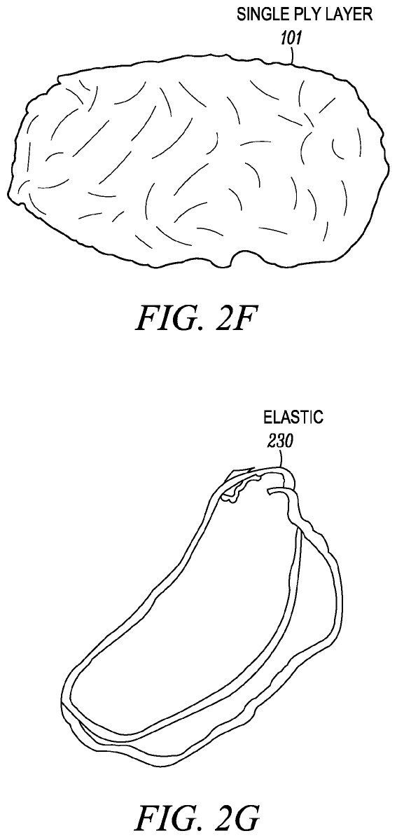

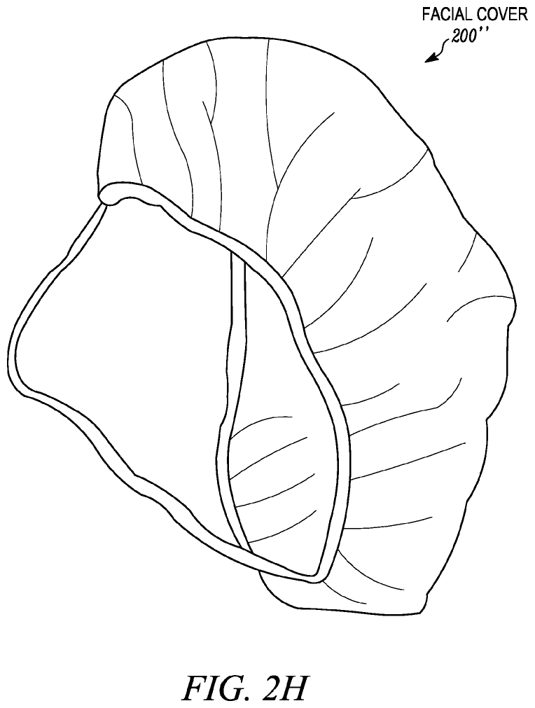

In one embodiment, the single ply layer 101 is used as a facial cover. FIG. 2A is an image that illustrates an example of a perspective view of the single ply barrier layer 101 of FIG. 1 worn as a facial cover 200, according to an embodiment. In an example embodiment, the facial cover 200 includes the single ply layer 101 with dimensions sufficient to cover the face of the user 203 (e.g. mouth and nose). In an example embodiment, the height of the single ply layer 101 is about 10 cm and/or in a range from about 5 cm to about 20 cm and/or the width of the single ply layer 101 is about 21 cm and/or in a range from about 15 cm to about 25 cm and/or the thickness of the single ply layer 101 is about 3 mm and/or in a range from about 2 mm to about 4 mm and/or from about 0.5 mm to about 5 mm. These ranges of numerical dimensions for the single ply layer 101 are merely one example of ranges of these numerical dimensions and thus the numerical dimensions may be selected outside these ranges.

In this embodiment, the first region is external surroundings 202 of a user 203 of the facial cover 200. Thus, in this embodiment, the outer surface 108 of the first side 106 is directed toward the external surroundings 202 (see FIG. 2A). Also, in this embodiment, the second region 204 is the face of the user 203 (e.g. a region between the face of the user 203 and the facial cover 200). In this embodiment, the facial cover 200 includes the single ply layer 101 that serves as the barrier 100 to prevent passage of the pathogen 110 from the external surroundings 202 to the user 203 (e.g. to prevent contamination of the user 203 by the external surroundings 202) and/or prevent passage of the pathogen 111 from the user 203 to the external surroundings 202 (e.g. to prevent contamination of the external surroundings 202 by the user 203).

In one embodiment, the facial cover 200 is secured to the face of the user 203 using ear loops 206. However, the embodiments of the present invention are not limited to this design. FIG. 2B is an image that illustrates an example of a perspective view of the single ply barrier layer 101 of FIG. 1 worn as a facial cover 200′, according to an embodiment. In an embodiment, unlike the facial cover 200 of FIG. 2A that is attached to the face of the user 203 with ear loops 206, the facial cover 200′ of FIG. 2B is attached to the face of the user 203 by directly affixing or adhering the facial cover 200′ to the face of the user 203 (e.g. without ear loops 206). In one example embodiment, an adhesive 208 is provided on the outer surface 118 of the second side 116 such that the second side 116 is configured to be directly attached to the face of the user 203 with the adhesive 208. In an example embodiment, the adhesive 208 is a mixture of isopropanol and partially hydrogenated rosin, e.g. 80% and 20% by weight, respectively. In an example embodiment, as shown in FIG. 2B, the adhesive 208 is provided along a perimeter of the outer surface 118 of the second side 116 such that the adhesive 208 is configured to form an air-tight seal between the single ply layer 101 and the user 203 when the second side 116 is directly attached to the face of the user 203. In an example embodiment, the adhesive 208 is a strip having a width of about 1.5 cm and/or in a range from about 0.5 cm to about 2 cm along the perimeter. The inventors of the present invention recognized that the facial cover 200′ provides distinct advantages over the facial cover 200 with the ear loops 206, such as reducing the risk of infection by preventing air leaking around the edges of the single ply layer 101 when the user 203 inhales (reducing infection of user) or exhales (reducing infection of exterior surroundings). Additionally, other distinct advantages of the facial cover 200′ include increased comfort and not having to remove the ear loops 206 in certain situations (e.g. when getting a haircut) and other advantages (e.g. less fogging of glasses, etc.).

FIG. 2C is an image that illustrates an example of a cross-sectional view of the single ply barrier layer 101 of FIG. 2A taken along the line 2C-2C. In an embodiment, FIG. 2C also depicts a cross-sectional view of the single ply layer 101 of FIG. 2B. The cross-sectional view of FIG. 2C is only taken along a portion of the height of the facial cover 200 (e.g. between a top and bottom of the facial cover 200 making contact with the user 203. As shown in FIG. 2C, in one embodiment the second region 204 is positioned between the face of the user 203 and the outer surface 118 of the second side 116. In an embodiment, as shown in FIG. 2C, the pathogen 210 is incident from the external surroundings 202 on the outer surface 108 of the facial cover 200 and thus the pathogenicidal components 112 coated on the outer surface 108 are configured to kill and/or deactivate the incident pathogen 210. In an embodiment, as shown in FIG. 2C, the pathogen 211 is incident from face of the user 203 on the outer surface 118 of the facial cover 200 and thus the pathogenicidal components 112 coated on the outer surface 118 are configured to kill and/or deactivate the incident pathogen 211.

In yet another embodiment, the facial cover can be attached to the user 203 using a fastener (e.g. elastic) that secures around the head of the user 203. FIGS. 2D and 2E are images that illustrates an example of a facial cover 200″ that is configured to secure to the face of the user 203 using a fastener (e.g. elastic 230). In an embodiment, as shown in FIG. 2D, the facial cover 200″ is oval shaped with a main radius 222 having a value of about 38 centimeters (cm) or in a range from about 30 cm to about 40 cm and a minor radius 224 of about 20 cm and/or in a range from about 15 cm to about 25 cm.

In another embodiment, as shown in FIG. 2E, the facial cover 200″ is circular shaped. In an embodiment, the elastic 230 is attached to two anchor points 232a, 232b of the facial cover 200″. In an example embodiment, the anchor points 232a, 232b are along a perimeter of the outer surface 118 that faces the user 203. In an example embodiment, a length of the elastic 230 is adjustable, so that the facial cover 200″ can fit a range of users 203. In another embodiment, the facial cover 200″ is secured to the user 203 by first positioning the outer surface 118 in close proximity to the face of the user 203 and then expanding the elastic 230 behind the head of the user 203 to hold the facial cover 200″ on the face of the user 203. FIGS. 2F through 2H show other images that illustrate an example of the single ply layer 101 used to make the facial cover 200″ (FIG. 2F); the elastic 230 used to secure the facial cover 200″ to the user 203 (FIG. 2G) and the facial cover 200″ with the attached elastic 230 (FIG. 2H).

Although the embodiments discussed with respect to FIGS. 2A through 2H disclose using the single ply layer 101 (e.g. without additional layers) as a facial cover, the embodiments of the present invention are not limited to this arrangement. In other embodiments, a facial cover is provided that includes using the single ply layer 101 in conjunction with a conventional mask (e.g. N95). In these embodiments, the single ply layer 101 is used to reduce contamination of the conventional mask (e.g. by killing or deactivating incident pathogens on the mask) and thus advantageously extends the lifetime of the conventional mask.

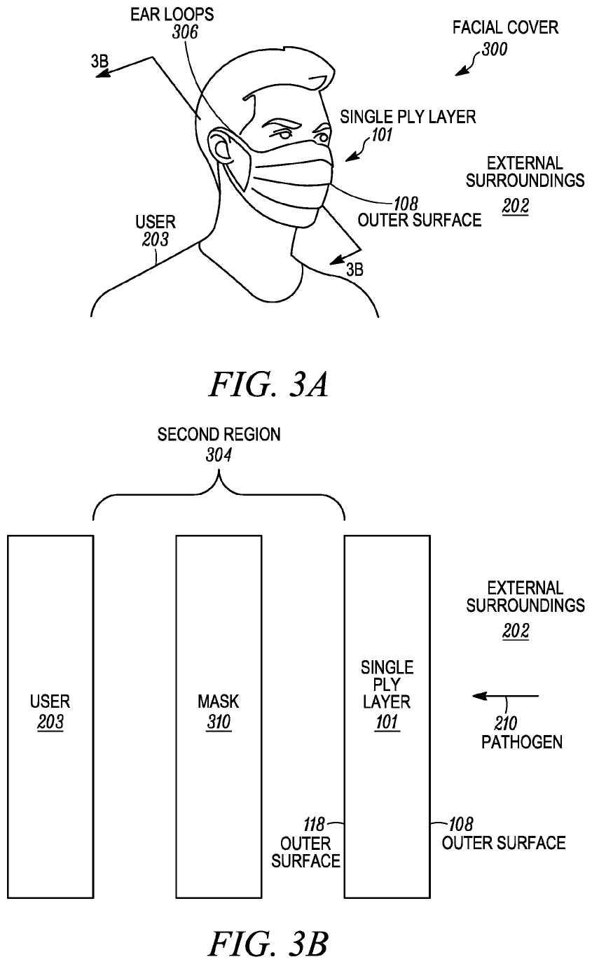

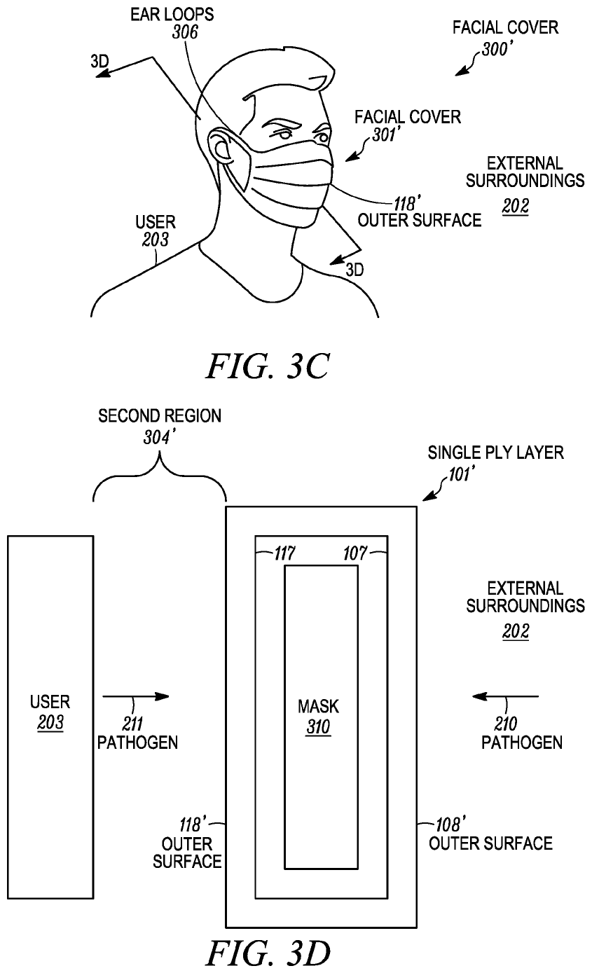

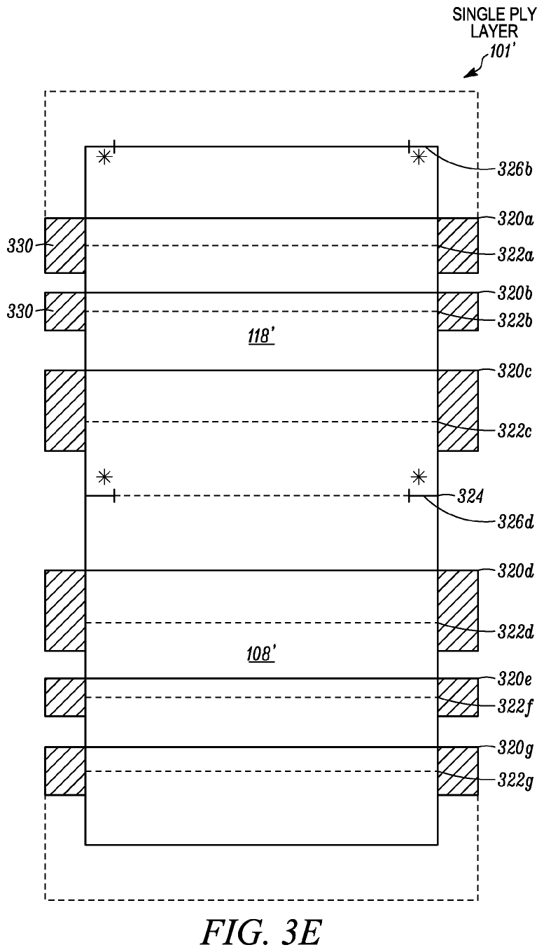

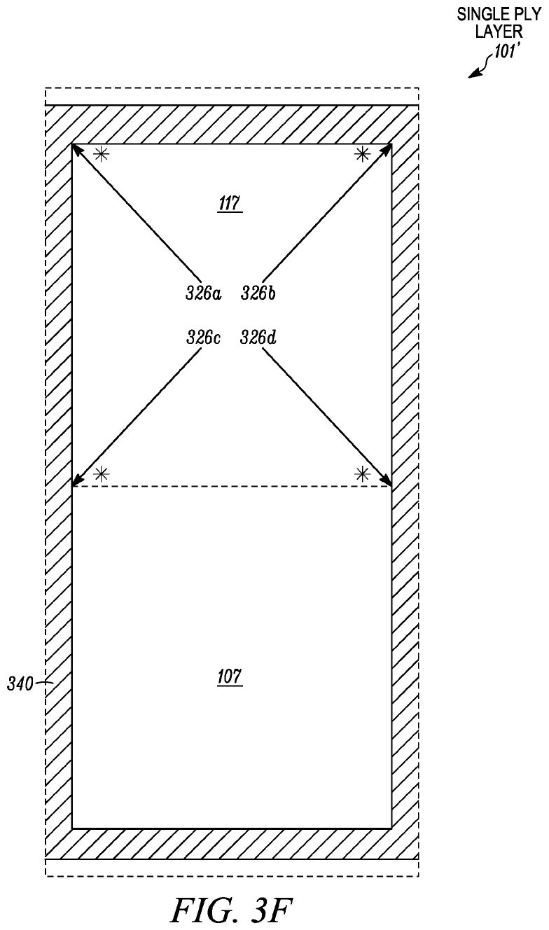

In one embodiment, the single ply layer 101 is used to over the outside of the conventional mask (e.g. the side of the mask facing the exterior surroundings of the user). In an example embodiment, the conventional mask 310 includes one or more untreated layers (e.g. that are not treated with pathogenicidal components) and thus are susceptible to surface contamination by pathogens. FIG. 3A is an image that illustrates an example of a perspective view of a facial cover 300 including the single ply barrier layer 101 of FIG. 1 covering a mask 310, according to an embodiment. FIG. 3B is an image that illustrates an example of a cross-sectional view of the facial cover 301 of FIG. 3A taken along the line 3B-3B. As shown in FIG. 3A, the ear loops 306 are used to secure the conventional mask 310 to the face of the user 203. The single ply layer 101 is positioned on an outside of the conventional mask 310 (e.g. between the conventional mask 310 and the external surroundings 202) to prevent contamination of the conventional mask 310 by pathogens 210 (e.g. by killing or deactivating viral particles in an aerosol droplet) incident on the mask 310. In this embodiment, the outer surface 108 of the first side 106 of the single ply layer 101 is oriented towards the external surroundings 202. As shown in FIG. 3B, the conventional mask 310 is positioned within the second region 304 (e.g. between the user 203 and the single ply layer 101).

In another embodiment, the single ply layer 101 is used to enclose the conventional mask (e.g. cover both sides of the mask facing the external surroundings 202 and facing the user 203 when worn on the face). FIG. 3C is an image that illustrates an example of a perspective view of a facial cover 300′ including the single ply barrier layer of FIG. 1 enclosing a mask 310, according to an embodiment. FIG. 3D is an image that illustrates an example of a cross-sectional view of the facial cover 300′ of FIG. 3C taken along the line 3D-3D. Unlike the facial cover 300 of FIGS. 3A and 3B, the facial cover 300′ of FIGS. 3C and 3D includes the single ply layer 101 that covers both sides of the conventional mask 310 (e.g. the side of the conventional mask 310 facing the external surroundings 202 and the side of the conventional mask facing the user 203).

In still other embodiments, the single ply layer 101 encloses the conventional mask 310 (e.g. such that all surfaces of the conventional mask 310 are covered by the single ply layer 101). As shown in FIG. 3D, the single ply layer 101′ encloses the conventional mask 310 such that the outer surface 108′ of the first side 106 is positioned to kill or deactivate pathogens 210 incident on the conventional mask 310 from the external surroundings 202 and the outer surface 118′ of the second side 116 is positioned to kill or deactivate pathogens 211 incident on the conventional mask 310 from the user 203 (e.g. breathed out through the mouth and/or aerosol droplets due to sneezing, etc.). Thus, the single ply layer 101′ of FIG. 3D advantageously kills or deactivates pathogens 210, 211 incident on the conventional mask 310 from both regions 202, 304′, thereby minimizing the risk of contamination of the conventional mask 310 and thus extending the lifetime of the conventional mask 310.

In one embodiment, the single ply layer 101′ is an integral barrier such that the outer surface 108′ and the outer surface 118′ are part of the same single piece of material. In other embodiments, the outer surface 108′ and the outer surface 118′ are from separate pieces of the single ply layer 101′ and thus are not integral. In an example embodiment, where the outer surfaces 108′, 118′ are separate pieces of material, each of these outer surfaces 108′, 118′ are adhered to the conventional mask 310 (e.g. using an adhesive).

As discussed with respect to FIGS. 3C and 3D, in one embodiment, the single ply layer 101′ is a single piece of integral material that encloses the conventional mask 310. FIGS. 3E and 3F are images that illustrate an example of a respective front view and rear view of this single ply layer 101′ prior to enclosing the mask 310. In an embodiment, FIGS. 3E and 3F depict the single ply layer 101′ of FIG. 3D prior to enclosing the conventional mask 310. In one embodiment, the single ply layer 101′ is folded around an edge (e.g. top edge) of the conventional mask 310 and fasteners are used to secure the single ply layer 101′ to itself around an opposite edge (e.g. bottom edge).

FIG. 3E depicts the outer surface 108′ and the outer surface 118′ of the single ply layer 101′ separated by a fold line 324 over which the single ply layer 101′ is folded to enclose the conventional mask 310. Additionally, in an embodiment, spaced apart adhesive strips 330 are provided along respective sides of the outer surfaces 108′, 118′ such that the respective sides of the single ply layer 101′ can adhere outside the sides of the conventional mask 310. Additionally, in an embodiment, multiple slits or openings 326a through 326d are provided adjacent the four corners of the outer surface 118′ through which the ear loops 306 of the conventional mask 310 are passed before securing behind the ears of the user 203. In yet another embodiment, multiple folds 320, 322 are provided along the outer surfaces 108′, 108′ with various spacings between the folds 320, 322 as shown (e.g. in a range from about 1.5 cm to about 4 cm). In an embodiment, a width of the outer surfaces 108′, 118′ is about 20 cm or in a range from about 15 cm to about 25 cm. In another embodiment, a height of the single ply layer 101′ is about 33 cm or in a range from about 25 cm to about 40 cm.

FIG. 3F depicts the inner surface 107′ and the inner surface 117′ (FIG. 3D) of the single ply layer 101′ that respectively face the front and rear surfaces of the enclosed conventional mask 310 when the single ply layer 101′ is folded to enclose the conventional mask 310. In an embodiment, the four openings 326a through 326d are also depicted in FIG. 3F through which the ear loops 306 are configured to extend. An adhesive 340 is provided along the perimeter of the inner surfaces 107′, 117′ such that the sides of the inner surfaces 107′, 117′ can self-adhere when the single ply layer 101′ is folded to enclose the conventional mask 310.

Based on the previously disclosed embodiments, the single ply layer 101′ allows users to reduce their exposure to infectious pathogens. In one embodiment, the single ply layer 101′ is a pleated mask cover, with flexibility similar to a surgical mask, wraps around the user's mask 310, and provides a sealed environment with the aid of the adhesive 330, 340 to prevent contamination of the mask, and also has flexibility to fit to the user's face and allow a snug fit such as is required when using N95 and similar masks/respirators. The mask cover has slits 326a through 326d to allow the passage of straps when using a mask with that form factor, similar to a surgical mask. In another embodiment, the mask cover will also provide sealed protection if one is using a mask 310 with ear loops 306, or other methods used to fasten/secure to the user's head. In an example embodiment, the flaps for the adhesive seal are designed to peel away allowing the cover to be opened and remove the mask 310 without contaminating either the external or internal surfaces.

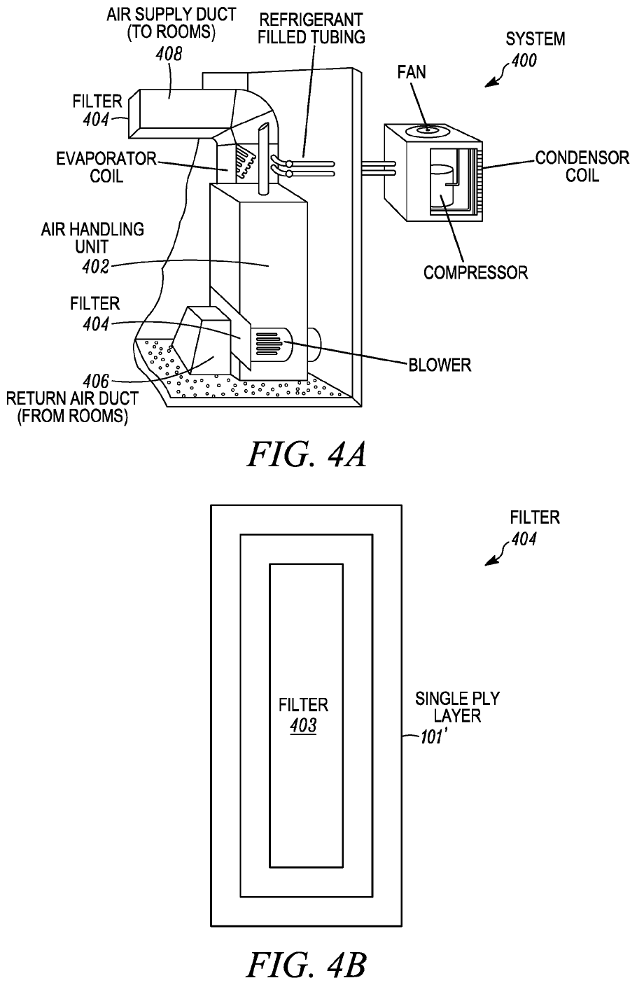

Although FIGS. 2A through 2H and FIGS. 3A through 3D discuss the single ply layer 101 being used in the context of facial covers, the embodiments of the present invention are not limited to this use of the single ply layer 101. In another embodiment, the single ply layer 101 is used in the context of air filters for air conditioning systems. The single ply layer 101 can advantageously be used to kill or deactivate pathogens that are present in the air circulated by air conditioning systems. FIG. 4A is an image that illustrates an example of a schematic diagram of the single ply barrier layer of FIG. 1 used as an air filter 404 in an air conditioning system 400, according to an embodiment. FIG. 4B is an image that illustrates an example of a schematic diagram of the air filter 404 of the air conditioning system 400 of FIG. 4A, according to an embodiment.

In one embodiment, the air filter 404 includes the single ply layer 101′ that is similar to the single ply layer 101′ discussed with respect to FIGS. 3D through 3F except the single ply layer 101′ is sized and configured to enclose a conventional air filter 403 used in the air conditioning system 400 (rather than enclosing a conventional mask 310). In one example embodiment, the single ply layer 101′ is used to enclose the air filter 403 positioned in the air handling unit 402 of the air conditioning system and thus advantageously kills or deactivates pathogens within air received through the return air duct 406. In this example embodiment, the first region 102 is the living space and the second region 104 is the air handling unit 402. In another example embodiment, the single ply layer 101′ is used to enclose the air filter 403 (or attached to a vent or grate) positioned at an outlet of an air supply duct 408 (to rooms) and thus advantageously kills or deactivates pathogens within air prior to being discharged into a living space. In this example embodiment, the first region 102 is the air supply duct 408 and the second region 104 is the living space (e.g. room where air from the duct 408 is directed).

In an embodiment, although FIGS. 4A and 4B depict the air filter 404 (with the single ply layer 101′) used in the air handling unit 402 of the air conditioning system 400 and at an outlet of the air supply duct 408, in some embodiments the air filter 404 is only used in one of the air handling unit 402 or the air supply duct 408. In still other embodiments, although FIG. 4B depicts that the filter 404 includes the single ply layer 101′ enclosing a conventional air filter 403, in other embodiments the filter 404 is just the single ply layer 101, 101′ (e.g. secured to an outer frame with dimensions about equal to the conventional filter slot in the air handling unit 402 or dimensions of the air supply duct 408 at the outlet).

In yet another embodiment, although FIGS. 4A and 4B depict the single ply layer 101, 101′ used with air filter for air conditioning systems 400 used for residences or businesses, in still other embodiments the single ply layer 101, 101′ can be used for air conditioning systems of vehicles (e.g. cabin vehicles including but not limited to planes, trains and automobiles, etc.). In these embodiments, the single ply layer 101, 101′ can be used to enclose the existing conventional air filters in the air conditioning systems of these vehicles or can be positioned (without the conventional air filter) adjacent an outlet (or inlet) of the air conditioning system of the vehicle, to kill or deactivate pathogens in air circulated within the air conditioning system.

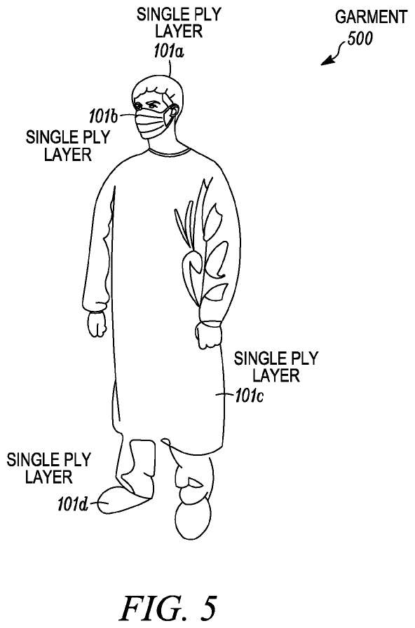

In one embodiment, another context where the single ply layer 101 can be used is in forming garments or clothing, particularly garments or clothing used in areas where pathogens are present (e.g. medical facility). In an example embodiment, the single ply layer 101 can be used to form garments worn by medical professionals (e.g. surgeons in a surgical room). In this example embodiment, the first region 102 is the external surroundings of the medical facility and the second region 104 is the body of the medical professional (e.g. covered by the garment). FIG. 5 is an image that illustrates an example of a schematic diagram of the single ply barrier layer 101a through 101d of FIG. 1 used to form a garment 500 worn by a medical professional (e.g. surgeon), according to an embodiment. In an example embodiment, the single ply layer 101a is used to form a head cover worn by the medical professional and/or the single ply layer 101b is used to form a facial cover worn by the medical professional and/or the single ply layer 101c is used to form a gown worn by the medical professional and/or the single ply layer 101d is used to form shoe covers worn by the medical professional. The inventors of the present invention recognized that using the single ply layers to form one or more garments worn by medical professionals would advantageously minimize the risk of infection or contamination of the medical professional by the external surroundings (and the external surroundings by the medical professional) while not affecting the level of comfort of the medical professional, due to the air permeability of the single ply layer. In an embodiment, the garment 500 is not limited to any particular garment (e.g. surgical gown) and includes isolation gowns (e.g. typically used in Intensive Care Unit (ICU) and can be single layer and relatively thin). In some example embodiments, surgical gowns employ multiple layers of the single ply layer 101 in order to achieve ensure certain performance parameters (e.g. prevent passage of liquid contaminants).

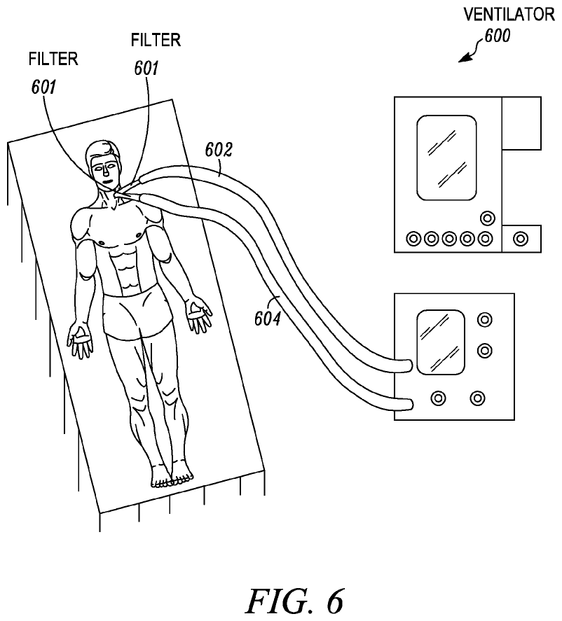

In one embodiment, another context where the single ply layer 101 can be used is for air filters used in ventilators. FIG. 6 is an image that illustrates an example of a schematic diagram of the single ply barrier layer of FIG. 1 used as a filter 601 in a ventilator 600, according to an embodiment. In this example embodiment, the first region 102 is an air supply duct 602 that directs air to the patient and the second region 104 is the patient. In yet another example embodiment, the first region 102 is the patient and the second region 104 is an air supply duct 604 that directs air from the patient to the ventilator 600.

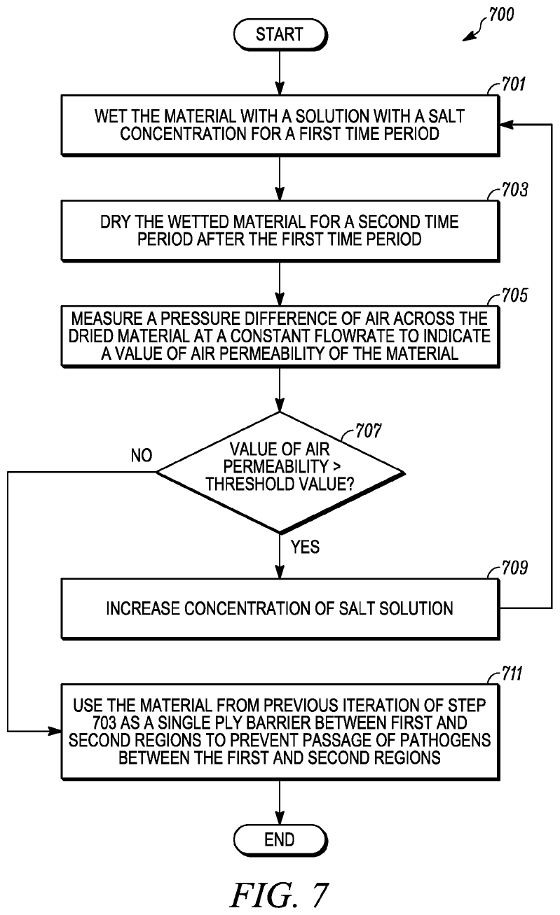

A method is now presented herein for forming the single ply layer 101. FIG. 7 is a flow chart that illustrates an example of a method 700 for forming the single ply barrier layer 101 of FIG. 1, according to an embodiment. Although steps are depicted in FIG. 7 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In an embodiment, the method 700 is configured to form the material of the single ply layer 101 in order to optimize one or more design parameters of the single ply layer 101. In one embodiment, one of the design parameters is the efficiency of the pathogenicidal components 112 in killing or deactivating pathogens. The inventors recognized that this efficiency is based on the concentration of pathogenicidal components 112 used in forming the single ply layer 101. In an example embodiment, where salt is employed as the virucidal components 112, this efficiency is based on a level of crystallization (LOC) of the salt. Another design parameter is the air permeability of the single ply layer 101, which affects the comfort of the user (e.g. breathability) wearing the facial cover including the single ply layer 101. Thus, in an embodiment, the method 700 is configured to optimize these two parameters (e.g. killing or deactivation efficiency of pathogens and breathability) of the single ply layer 101. The inventors of the present invention understood that varying one of the parameters may affect the other parameter. In an example embodiment the inventors of the present invention understood that increasing the level of concentration of the pathogenicidal components 112 (or level of crystallization of the salt) may decrease the air permeability (and thus the breathability) of the facial cover employing the single ply layer 101. Thus, in an example embodiment, the method 700 is employed to optimize values of these parameters in order to design the single ply layer 101 with a sufficient concentration of pathogenicidal components 112 to efficiently kill or deactivate the pathogens while simultaneously ensuring an adequate air permeability (and thus breathability).

In an embodiment, a sheet of material is used to form the single ply layer 101 (e.g. with a width and length of about 40 cm by 40 cm and/or with a width and length in respective ranges from about 10 cm to about 50 cm). In one example embodiment, the sheet of material is a thermo plastic material (e.g. polypropylene) and/or cotton blend (e.g. silk, wool, cotton, etc.).

In an embodiment, step 701 includes wetting material with a solution including pathogenicidal components with a concentration of a particular value. In one embodiment, the wetting of step 701 is performed over a first time period (e.g. about 20 hours). In an example embodiment, the solution has a salt concentration (e.g. in a range from about 0.02 ml/cm² to about 0.06 ml/cm² and/or in a range from about 0.01 ml/cm² to about 0.1 ml/cm² of salt).

In another embodiment, step 701 includes applying the pathogenicidal components (e.g. virucidal and/or bactericidal components) to the material and includes one or more of misting, spraying, sputtering, painting or soaking/submerging (e.g. for liquid components) and pelleting or powdering (e.g. for solid components) and applied in a dry coat, rolled, aerially dispersed, dry-sputtered, evaporated, pressured, and vacuum incorporated. In an example embodiment, dry powders may be ground into nanoparticles or suspended and emulsified in a liquid for applications to coat the mask cover. Gels and oils may be applied a liquid coating.

In an embodiment, step 701 includes submerging the material in a tank with the solution for the first time period such that the material is fully submerged and/or uniformly spraying the material with the solution and/or injecting, from an injectable platform, the solution into the material. In an example embodiment, step 701 includes submerging the material in a tank with a volume (e.g. about 34 mL) of solution for the first time period (e.g. about 12 hours) to transform hydrophobic properties and increase wetting/absorption, which is considered the pre-wetting process. In this example embodiment, a remaining volume (e.g. about 68 mL) is applied in the same manner prior to the drying step 703. In another example embodiment, the material is fully submerged in the tank of solution during the wetting step 701. It should be noted that the particular values of the parameters of the submerging discussed above (e.g. time period for the step 701, size of the material, volume of solution, etc.) can be adjusted based on the purpose of the material (e.g. facial cover, air filter, etc.).

In an embodiment, step 701 includes spraying the material placed in a petri dish or a plate of a necessary size (e.g. about 40 cm by 40 cm). In this embodiment, for all intents and purposes), the spraying step is performed using a jet or mist spray, and the solution is uniformly spread over the material. In an example embodiment, the first time period is about the same (e.g. about 12 hours) as for the submerging step. In an example embodiment, a volume of spray solution utilized in the spraying step is about 0.90 mL. In another example embodiment, a spray diameter used during the spraying step is about 15.5 cm when placed about 20 cm away from the material. It should be noted that the particular values of the parameters of the spraying discussed above (e.g. time period for the step 701, size of the material, volume of solution, volume of spray, etc.) can be adjusted based on the purpose of the material (e.g. facial cover, air filter, etc.). It should be noted that the particular values of the parameters of the spraying discussed above (e.g. time period for the step 701, size of the material, volume of spray, diameter of spray, etc.) can be adjusted based on the purpose of the material (e.g. facial cover, air filter, etc.).

In an embodiment, step 701 includes injecting the material with the solution. In this embodiment, the injecting is performed using an injectable platform and syringe needles with a gauge in a certain range (e.g. from about gauge 28 to about gauge 32 with an inner diameter ranging from about 0.18 mm to about 0.11 mm). In an example embodiment, the active wetting area is about 2.7 mm. In another embodiment, the needles are aligned on a platform of width equal (e.g. about 40 cm) to the sheet of material. In an example embodiment, the solution is equally divided to penetrate, inject, and impregnate material immediately with no prewetting time. In an example embodiment, step 701 involves about 22,500 syringes each delivering about 0.004 mL in one step, thus eliminating the need for a pre-wetting step. In another example embodiment, the volume is well above the dead volume of needles that size, allowing optimal priming of each syringe.

In an embodiment, step 703 including drying the wetted material from step 701 for a second time period (e.g. about 10 hours or in a range from about 8 hours to about 15 hours) after the first time period. In one embodiment, step 703 is performed in one of an oven or an airtight vessel, where the second time period for the drying step in the airtight vessel is less than the second time period for the drying step in the oven. In an example embodiment, in step 703 the drying may be undertaken at a temperature in a range from about 20 degrees C. to about 100 degrees C., and sterilization may be performed with either heat (e.g. from about 20 degrees C. to about 100 degrees C.) or with gas sterilization.

In an embodiment, the drying step 703 involves conventional drying, where the material is placed in a conventional oven of uniform temperature and throughout brought by a fan in the rear. In this embodiment, the drying step 703 is performed for about 24 hours. In another embodiment, the drying step 703 involves vacuum drying performed in an airtight vessel, where the relative humidity and pressure are drastically reduced. In this example embodiment, with the atmospheric pressure lowered, materials can dry much more rapidly. In an example embodiment, the boiling point of water significantly decreases (e.g., from about 100 degrees to about 35 degrees C.), as a result the rate of evaporation increases, allowing drying that would take 24 hours at atm to take place within hours, depending on the specific conditions set.

In an embodiment, step 705 includes measuring an air permeability of the material after step 703. In one embodiment, the measuring of the air permeability includes measuring an air pressure difference across the material after step 703 based on a constant flowrate across the material.

In an embodiment, step 707 includes comparing the value of the air permeability measured in step 705 with a threshold value of air permeability (e.g. corresponding to an air pressure difference equal to or less than 0.2 mm H₂O/cm²). If the measured value of the air permeability from step 705 is greater than the threshold value, the method 700 moves to block 709. If the measured value of the air permeability from step 705 is not greater than the threshold value, then the method 700 moves to block 711.

In an embodiment, step 709 includes increasing the concentration of the pathogenicidal components 112 in the solution (e.g. increasing the concentration of salt in the solution) and then repeating steps 701 through 707 for the increased concentration value of the solution.

In an embodiment, step 711 includes using the material from the previous iteration of step 703 as the single ply layer 101. In one embodiment, steps 701 through 707 are repeated provided that the measured air permeability is greater than the threshold value of air permeability. Once step 707 indicates that the value of the air permeability is less than the threshold value of the air permeability, this indicates that the concentration of the pathogenicidal components 112 is too high and thus adversely affecting the air permeability. Thus, the concentration of the pathogenicidal components 112 in the previous iteration of steps 701 through 707 is utilized in step 711 to form the single ply layer 101. In an example embodiment, if the fourth iteration of steps 701 through 707 indicates that the measured air permeability is less than the threshold value, then the value of the concentration used in the third iteration of steps 701 through 707 is employed in step 711 to form the single ply layer 101. This concentration of pathogenicidal components 112 advantageously provides an effective balance between a high concentration of pathogenicidal components 112 (e.g. to maximize the killing or deactivation of the pathogens) while still ensuring an acceptable level of air permeability. The inventors of the present invention found a surprising result—despite four iterations of steps 701 through 709 and four consecutive increases in the salt concentration of the solution, the measured air permeability exceeded the threshold value in step 707 for each iteration. This is a surprising result since the inventors expected that an increase the salt concentration of the solution would cause reduced air permeability (e.g. since the increased concentration of salt crystals were expected to partially cover some of the pores). Thus, in one embodiment, the inventors performed the method 700 and utilized the highest concentration value among four consecutive increases (four iterations of steps 701 through 709). In one example embodiment, increasing values of the salt concentration used during the four iterations of steps 701 through 709. In an example embodiment, these increasing values of concentration for each iteration of steps 701 through 709 include 0.02122 ml/cm², 0.03182 ml/cm², 0.04244 ml/cm² and 0.06367 ml/cm². However, these example values of the salt concentration are just one example of values and the values of the salt concentration employed in the method herein are not limited to these particular values or these particular range of values.

The treated material with the virucidal components (from steps 701 and 703) has certain properties and characteristics. In an embodiment, due to the application of the solution to the polypropylene sheet (step 701), the material exhibits certain properties and characteristics that differ drastically from the bare sheet utilized in current conventional masks 310 (e.g. conventional surgical masks). Contact Angle (Θ_{C}) is defined as a quantity measuring ability of a liquid to the wet the surface of a solid. In addition to the formation of salt crystals in the material (e.g. NaCl crystals) on the material (e.g. polypropylene fibers), the presence of surfactant altered the surface properties from hydrophobic (e.g. Θ_{C} is about 134±5°) to hydrophilic (e.g. Θ_{C} is about 0°). As a result, the adhesion of viral aerosols to the fibers is greatly improved.

In one embodiment, during use of the single ply layer 101 formed by the method 700, once the outer surface 108, 118 is exposed to virus aerosols, the salt crystals at the point of contact dissolve and gradually increase the osmotic pressure in the viral cells. In this embodiment, evaporation takes place, causing the salt concentration to shift from the higher concentration of the single ply layer 101 into the virus eventually leading to the oversaturation of the cell. Once the solubility limit is reached, recrystallization of the salt commences. During drying, viruses and bacterial cells are exposed to even more osmotic pressure, eventually reaching hyperosmotic stress (e.g. about >541 mOsm). The combination of crystallization and intercellular stress, prompts irreversible deformation of the viral envelope and overall structural damage causing infectivity loss of the virus.

In one embodiment, the level of crystallization (LOC) of the salt virucidal components used in the material is measured during X-ray diffraction. X-Ray diffraction analysis is a commonly used method for microstructural analysis, specifically to determine the crystallographic structure of the material. Results of this analysis are quantified by Miller indices, a set of three compound specific numbers indicating the orientation of planes of atoms in a crystal. FIG. 8B is an image that illustrates an example of different miller indices 850 and the associated orientation of the plane of atoms in the crystal for that respective indices.

X-ray diffraction (XRD) is the experimental science determining the atomic and molecular structure of a crystal, in which the crystalline structure causes a beam of incident X-rays to diffract into many specific directions. By measuring the angles and intensities of these diffracted beams, a crystallographer can produce a three-dimensional picture of the density of electrons within the crystal. From this electron density, the mean positions of the atoms in the crystal can be determined, as well as their chemical bonds, their crystallographic disorder, and various other information.

Since many materials can form crystals-such as salts, metals, minerals, semiconductors, as well as various inorganic, organic, and biological molecules-XRD has been fundamental in the development of many scientific fields. In a single-crystal X-ray diffraction measurement, a sample (e.g. single ply layer 101, 101′ formed by the method herein or a small portion thereof) is mounted on a goniometer. The goniometer is used to position the sample (e.g. layer 101, 101′) at selected orientations. The sample (e.g., single ply layer 101, 101′) is illuminated with a finely focused monochromatic beam of X-rays, producing a diffraction pattern of regularly spaced spots known as reflections. The two-dimensional images taken at different orientations are converted into a three-dimensional model of the density of electrons within the sample (e.g. single ply layer 101, 101′) using the mathematical method of Fourier transforms, combined with chemical data known for the sample.

FIG. 8A is an image that illustrates an example of a graph 800 that depicts the XRD spectra of the single ply layer 101 (curve 806) relative to the XRD spectra of the conventional mask 310 (curve 808). The horizontal axis 802 is the orientation of the sample (e.g. single ply layer 101, 101′) relative to the beam of X-rays employed in XRD. The vertical axis 804 is intensity (arbitrary units) which indicate an electron density within the sample (e.g. single ply layer 101, 101′). As shown by the curve 808 of FIG. 8A, multiple peaks 806a through 806i occur in the curve 808, indicating that a crystalline structure is present at that orientation of the sample (e.g. single ply layer 101, 101′). Also as shown in FIG. 8A a respective miller indices are indicated at each respective peak 806a through 806i which indicate the miller index for that respective peak. In an example embodiment, the peaks 806a through 806i collectively indicate the level of crystallization of the single ply layer 101, 101′ for each respective plane (miler index or peak in FIG. 8A) within the single ply layer 101, 101′.

In an embodiment, XRD produces a diffraction pattern which provides insight on the atomic structure within the salt crystals and the intensity associated with it quantifies the electron density in the crystalline lattice planes (in arbitrary units, see vertical axis 804). The inventors of the present invention recognized that when lower concentration values of salt were used, the intensity of the XRD diffraction pattern would respectively decline, since less salt was used. In an example embodiment, the peaks 806a, through 806i are correlated to that of NaCl, since every crystal has a specific miller indices. In an example embodiment, the average intensity achieved with the salt concentration values used herein was about 3 au (arbitrary units), with crystal specific peaks having higher values.

In one embodiment, a filtration efficiency of the single ply layer 101 is another parameter that is measured and utilized in developing the single ply layer 101. The purpose of particulate filtration efficiency (PFE) is to display adequate filtration of monodispersed particles under a constant flow rate (e.g. using ASTM F2299 method). In an embodiment, to measure the PFE of the single ply layer 101, a predetermined amount of polystyrene latex particles (e.g., mean particle diameter of about 0.216±0.0009 μm; Agar Scientific) are passed through the material at a constant flowrate (e.g. about 10 cm/second). Light scattering is used to quantify the particle count downstream. An efficiency value is calculated using:

$$E = 100 ( 1 - \frac{{M}_{d}}{{M}_{u}} ) \qquad ( 1 )$$

Where E is the value of the PFE; M_{d} is the particle count downstream of the single ply layer 101 and Mᵤ is the particle count upstream of the single ply layer 101. In one embodiment, M_{d} was held constant by using manufacturer particle concentration of about 1.80×10¹¹ n/mL.

Table 1 below indicates values of the PFE for a conventional fleece mask; a conventional 3 ply surgical mask and for the single ply layer 101 (or “amp shield” in Table 1). As indicated by the values of PFE in Table 1, the filtration efficiency of the single ply layer 101 is about 98.7% and higher than the filtration efficiency of both conventional masks.

TABLE 1

| Material | M₁₂ | M_{d} | E |
|---|---|---|---|
| Fleece Mass | 9 × 10⁹ | 2.722 × 10⁹ | 69.75% |
| 3 Ply Surgical Mask | 9 × 10⁹ | 2.196 × 10⁸ | 97.56% |
| Amp Shield | 9 × 10⁹ | 1.17 × 10⁸ | 98.7% |

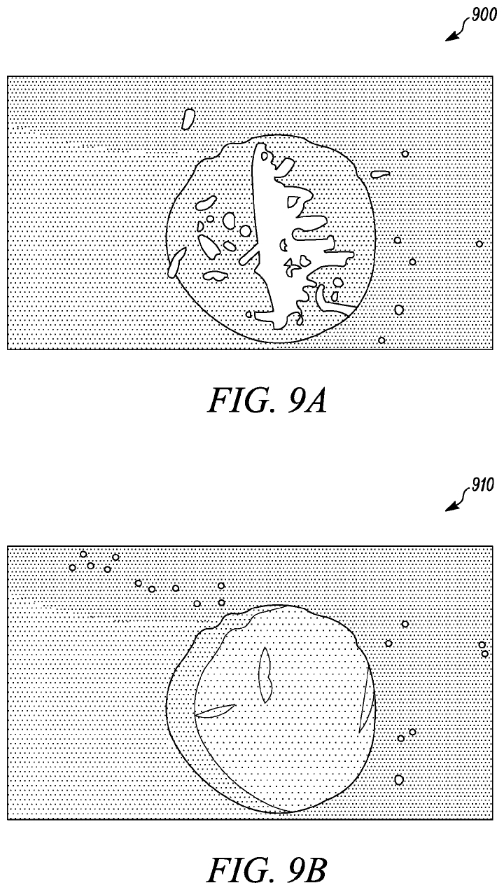

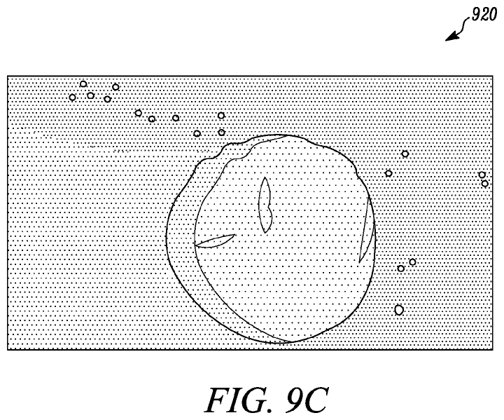

FIG. 9A is an image 900 that illustrates an example of light scattering of particles downstream of a conventional mask (e.g. Fleece mask), according to an embodiment. FIG. 9B is an image 910 that illustrates an example of light scattering of particles downstream of a conventional surgical mask (e.g. 3 ply surgical mask), according to an embodiment. FIG. 9C is an image 920 that illustrates an example of light scattering of particles downstream of the single ply barrier layer 101 of the facial cover 200 (e.g. Amp shield in Table 1) of FIG. 2A, according to an embodiment.

In one embodiment, a viral/bacterial filtration efficiency (VFE/BFE) of the single ply layer 101 is another parameter that is measured and utilized in developing the single ply layer 101. The purpose of VFE/BFE is to quantity performance of the single ply layer 101 in filtering out bacteria and viruses (e.g. using ASTM F2101 method). In one embodiment, the ASTM F2101 method that measures BFE is based on aerosolized liquid suspension of Staphylococcus aureus (e.g. mean particle size of 3.5±0.6 μm; Sigma Aldrich) passed through target material at a constant flow rate of 1 ft3/min in a six-stage Andersen sampler. Each of the tiers contain an agar plate acting as a medium for growth of any bacteria which passes through the material.

In one embodiment, the ASTM F2101 method that measures VFE is based on bacteriophage ΘX174 that is aerosolized (e.g., mean size of virus-containing water droplet 3.2±0.4 μm, not individual viruses), which only infects E. coli, and then targeted at sample. Rather than bare agar plates, they are inoculated with Escherichia coli.

For both BFE and VFE tests, results are compared to a control test in the absence of the single ply layer 101. The BFE and VFE are calculated using:

$$BFE = 100 ( \frac{C - F}{C} ) \qquad ( 2 )$$

$$VFE = 100 ( \frac{C - F}{C} ) \qquad ( 3 )$$

where C and F are the control and filter results. Tables 2 and 3 below indicates the values of BFE (Table 2) and VFE (Table 3) for the single ply layer 101 (AMP) and the control. As indicated by the values of BFE in Table 2 and VFE in Table 3, the BFE and VFE values of the single ply layer 101 is about 99.4-99.5%.

TABLE 2

| | Initial | Final | |
|---|---|---|---|
| Material | Sample (CFU) | Sample* (CFU) | BFE |
| Control | 1500 | 1494 | 0.4% |
| AMP | 1500 | 9 | 99.4% |

TABLE 3

| | Initial | Final | |
|---|---|---|---|
| Material | Sample (PFU) | Sample* (PFU) | VFE |
| Control | 1100 | 1098 | 0.18% |
| AMP | 1100 | 5 | 99.54% |

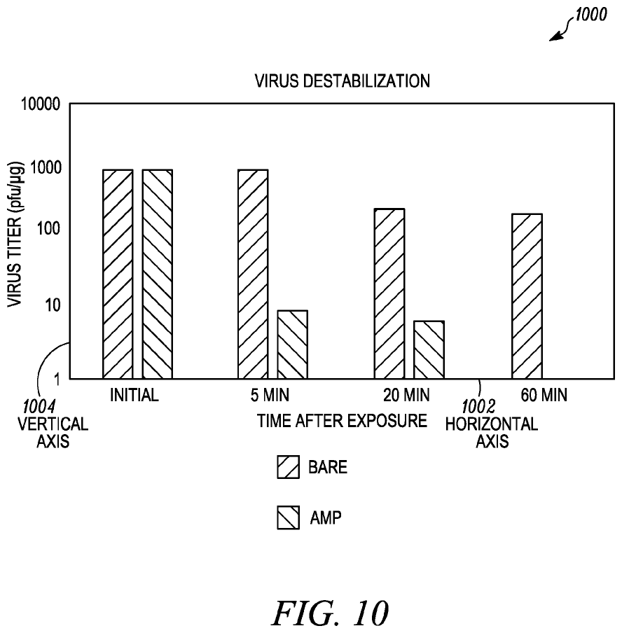

FIG. 10 is an image that illustrates an example of a graph 1000 that depicts the VFE of the single ply barrier layer 101 of FIG. 1, according to an embodiment. The horizontal axis 1002 is time of exposure in units of minutes and the vertical axis 1004 is virus tiers in units of pfu/μg). In an embodiment, the left bar at each time value indicates the virus tiers in the conventional mask 310 and the right bar at each time value indicates the virus tiers in the single ply layer 101, 101′. As shown in FIG. 10, both the conventional mask 310 and single ply layer 101, 101′ have the same virus tier value (about 1000) at the initial exposure time. As further shown in FIG. 10, after 5 minutes of exposure, the conventional mask 310 still has the same virus tier value (about 1000) at the initial exposure time whereas the single ply layer 101, 101′ has a much smaller value (about 10) than at the initial exposure. This confirms that after merely 5 minutes, the single ply layer 101, 101′ has deactivated or killed at least 95% of the virus tiers at the initial exposure time. FIG. 10 also shows that at later exposure times (e.g. 20 minutes, 60 minutes) the virus tier level on the conventional mask 310 remains relatively high (about 700) whereas the virus tier level on the single ply layer 101, 101′ reduces to about 0. In another embodiment, almost complete hemagglutinin (HA) activity loss was exhibited. Specifically, glycoprotein was found on the surface of viruses, integral to their infectivity. Through microscopic analysis, it was confirmed that the aerosol drying time was nearly 3 minutes. This indicates that destruction of virus is correlated with the drying induced salt crystallization.

In one embodiment, a fluid resistance of the single ply layer 101 is another parameter that is measured and utilized in developing the single ply layer 101. The purpose of fluid resistance is to provide adequate resistance to the transfer of fluids from its out to its inner layers due to splashing or spraying. In an example embodiment, a particular method is employed to measure the fluid resistance (e.g. ASTM F1862). In an example embodiment, 2 mL of synthetic blood is targeted at the single ply layer 101 at varying velocities corresponding to the following blood pressures: 80 mmHg: Level 1, venous blood pressure; 120 mmHg: Level 2, arterial pressure; and 160 mmHg: Level 3, high pressures occurring during trauma. In one embodiment, the single ply layer 101 is an accessory to current masks, extending the lifetime of current masks while additionally reducing the number of possible fomites and as a result, reduction in cross contamination. Depending on the setting, the single ply layer 101 adapts, at all three levels improving barrier efficiency by adding an additional layer. ASTM defines passing as having at least 29 of 32 masks not showing fluid onto opposite side. Table 4 below indicates the amount of single ply layers 101 that passed and failed, at each level.

TABLE 4

| Pressure | Pass | Fail |
|---|---|---|
| 80 mmHg | 32 | 0 |
| 120 mmHg | 32 | 0 |
| 160 mmHg | 31 | 1 |

In one embodiment, air exchange (or air permeability) of the single ply layer 101 is another parameter that is measured and utilized in developing the single ply layer 101. The air exchange parameter, commonly referred to as ΔP, indicates sufficient breathability for the user wearing the facial cover (made from the single ply layer 101). That is, the ability of the single ply layer 101 to restrict airflow through it (e.g. using method EN 14683). In an embodiment the method for measuring air exchange (or air permeability) is employed in step 705 of the method 700 and measures the air pressure difference on both sides of the single ply layer 101 using a manometer, with airflow supplied at a constant flowrate. Table 5 below indicates the values of the air exchange (or air permeability) for the requirement of FDA approval (top row of Table 5), the conventional mask 310 (second row of Table 5) and the facial cover 300 including the conventional mask 310 and the single ply layer 101 (third row of Table 5). Thus, in one embodiment, the air exchange (or air permeability) is based on the difference between the third row and second row of Table 5 (e.g. in a range from about 0.05 to about 0.07 mmH₂O/cm²).

TABLE 5

| | Level 1 | Level 2 | Level 3 |
|---|---|---|---|
| Required | <4.0 mmH₂O/cm² | <5.0 mmH₂O/cm² | <5.0 mmH₂O/cm² |
| Bare Mask | 3.8 mmH₂O/cm² | 4.5 mmH₂O/cm² | 4.7 mmH₂O/cm² |
| Mask | 3.87 mmH₂O/cm² | 4.56 mmH₂O/cm² | 4.79 mmH₂O/cm² |
| w/Shield | | | |

Table 6 below also indicates a summary of the measured performance parameters of the single ply layer 101 (far right column of Table 6) for various levels.

TABLE 6

| Characteristic | Level 1 | Level 2 | Level 3 | AMP |
|---|---|---|---|---|
| Fluid | 80 | 120 | 160 | Pass |
| Resistance (mmHg) | | | | |
| BFE Percent | 95% | 98% | 98% | 90.40% |
| PFE Percent | 95% | 98% | 98% | 90.7% |
| VFE Percent | — | — | — | 90.54% |
| Differential | | | | |
| Pressure | | | | |
| (ΔP breathability) | <4.0 | <5.0 | <5.0 | Pass |
| (mmH₂O/cm²) | | | | |
| Flammability | Class 1 | Class 1 | Class 1 | Pass |
| (flame spread) | | | | |

What is claimed is:

1. A barrier configured to be placed between a first region and a second region, to prevent passage of pathogens between the first region and the second region, wherein the barrier comprises:
a single ply layer treated with pathogenicidal components, said single ply layer including;
a first side directed toward the first region, said first side including an outer surface coated with the pathogenicidal components such that pathogens in the first region are incident on the outer surface of the first side, and
a second side directed toward the second region, said second side including an outer surface coated with the pathogenicidal components such that pathogens in the second region are incident on the outer surface of the second side;
wherein the pathogenicidal components coated on the outer surfaces of the first side and the second side are configured to deactivate the pathogens incident on the outer surface of the respective first side and the second side.

2. The barrier of claim 1, wherein the barrier only includes the single ply layer and excludes additional layers positioned between the first region and the second region.

3. The barrier of claim 1, wherein the pathogenicidal components comprise one or more of salt, acid and esters.

4. The barrier of claim 3, wherein the pathogenicidal components are virucidal components comprising salt with a level of crystallization of across a thickness of the single ply layer from the outer surface of the first side to the outer surface of the second side.

5. The barrier of claim 1, wherein the single ply layer has an air permeability such that an air pressure difference between the first side and the second side is less than about 0.2 mm H₂O/cm² based on an airflow through the single ply layer at a constant flowrate.

6. The barrier of claim 5, wherein the air pressure difference is less than about 0.1 mm H₂O/cm².

7. The barrier of claim 1, wherein the barrier has a viral filtration efficiency of at least 95% between the first region and the second region.

8. The barrier of claim 1, wherein the barrier is configured to be worn on a face of a user, such that the first region is an external surrounding of the user and the second region is the face of the user.

9. The barrier of claim 8, further comprising an adhesive on the outer surface of the second side such that the second side is configured to be directly attached to the face of the user with the adhesive.

10. The barrier of claim 9, wherein the adhesive is provided along a perimeter of the outer surface of the second side such that the adhesive is configured to form an air-tight seal between the barrier and the user when the second side is directly attached to the face of the user.

11. A facial cover to be worn by a user, comprising:
a first barrier of claim 8;
a secondary layer not treated with pathogenicidal components, said secondary layer positioned between the second side of the single ply layer and the face of the user;
wherein the first barrier is configured to deactivate pathogens incident from the external surrounding of the user to prevent contamination of the secondary layer.

12. The facial cover of claim 11, further comprising a second barrier of claim 8 positioned between the secondary layer and the face of the user;
wherein the second barrier is configured to deactivate pathogens incident from the face of the user to prevent contamination of the secondary layer.

13. The facial cover of claim 12, wherein the first barrier and the secondary barrier are an integral barrier including an integral single ply layer configured to enclose the secondary layer such that pathogens incident from the first region or the second region are deactivated by the integral barrier to prevent contamination of the secondary layer.

14. The facial cover of claim 12, wherein the first barrier and the second barrier are separate barriers with separate single ply layers.

15. The barrier of claim 1, wherein the barrier is an air filter configured to be placed in a conduit of an air conditioning system, wherein the first region is the conduit configured to direct a flow of air and wherein the second region is an area to receive the flow of air after passing through the air filter.

16. The barrier of claim 1, wherein the barrier is an air filter configured to be placed in a conduit of a respirator used with a patient, wherein the first region is the conduit configured to direct a flow of air exhaled by the patient and wherein the second region is external surroundings of the respirator in a medical facility.

17. The barrier of claim 1, wherein the barrier is a garment configured to be worn by a medical professional, wherein the first region is external surroundings of the medical professional in a medical facility and the second region is the body of the medical professional.

18. A method for forming the barrier of claim 1, comprising:
a) wetting material with a solution comprising pathogenicidal components with a concentration having a value for a first time period;
b) drying the material for a second time period after the first time period;
c) measuring a value of air permeability of the dried material after the second time period;
d) comparing the measured value of the air permeability with a threshold value of the air permeability; and
e) using the dried material in step b) to form the single ply layer of claim 1 based on the measured value of the air permeability being greater than the threshold value.

19. The method of claim 18, further comprising:
when the measured value of the air permeability in step c) is greater than the threshold value, the method further comprises increasing the value of the concentration of the pathogenicidal components and repeating steps a) through d) with the increased value of the concentration;
and wherein the dried material used in step e) is based on a highest value of the concentration of the pathogenicidal components for which the measured air permeability is greater than the threshold value.

20. The method of claim 18, wherein the wetting step comprises submerging the material in a tank with the solution for the first time period such that the material is fully submerged.

21. The method of claim 18, wherein the wetting step comprises uniformly spraying the material with the solution.

22. The method of claim 18, wherein the wetting step comprises injecting, from an injectable platform, the solution into the material.

23. The method of claim 18, wherein the drying step is performed in one of an oven or an airtight vessel, wherein the second time period for the drying step in the airtight vessel is less than the second time period for the drying step in the oven.
